(19) United States
(12) Patent Application Publication
(10) Pub. No.: US 2007/0235962 A1
(43) Pub. Date: Oct. 11, 2007

(54) Artificial tree container

(76) Inventor: Limber Jamie, Phoenix, AZ (US)

Correspondence Address: The Halvorson Law Firm, Ste 130, 1757 E. Baseline Rd., Gilbert, AZ, 85233, US

(21) Appl. No.: 11/377,263

(22) Filed: Mar. 15, 2006

Related U.S. Application Data
(63) Continuation of application No. 29/245,089, filed on Dec. 19, 2005.

(51) Int. Cl. B62B 1/00; B62B 7/02

(52) U.S. Cl. 280/47.26

(57) ABSTRACT

A storage container for artificial trees comprising a container portion, a transportation portion that is attached to a base of the container portion, and a handle portion that is attached to a top end of the container portion. The container portion is made of a soft flexible material, such that the container portion may be compressed or rolled-up when not containing an artificial tree. The container portion is preferably a truncated pyramid, with a base, at least one side section and a top. The side section and the top are bisected by a reusable closure mechanism. Attached to the base is the transportation portion, which comprises a transverse spine to which at least one wheel mechanism is attached. Attached to an upper end of the container portion is a handle portion. The handle portion is at least one loop that spans the top of the container portion.

This application is a continuation of pending application Ser. No. 29/245,089, filed on Dec. 19, 2005.

### FIELD OF THE INVENTION

The present invention relates to the field of storage for artificial trees such as artificial Christmas trees.

### BACKGROUND

Artificial trees, such as artificial Christmas trees, are useful decorative devices. However, when the decorative need has abated, the problem of storing the artificial tree arises.

An unpopular method for temporarily storing artificial trees is to merely prop them into a corner, such as a corner in the garage. This however does not protect the artificial trees from damage and/or dust.

Another method, especially for multi-piece artificial trees is to disassemble the artificial tree and replace it in the original packaging. The problem with this method is the requirement of keeping the original packaging, typically a bulky box or other structure.

Thus, there are present and continuing needs for new and improved artificial tree storage solutions.

### SUMMARY OF THE INVENTION

It is an object of the present invention to provide a storage container for artificial trees.

It is another object of the present invention to provide a storage container for artificial trees, such as artificial Christmas trees.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a perspective view of the Christmas Tree Container, according to the present invention;

FIG. 2 is a side view of the Christmas Tree Container, according to the present invention;

FIG. 3 is a second side view of the Christmas Tree Container, according to the present invention;

FIG. 4 is a third side view of the Christmas Tree Container, according to the present invention;

FIG. 5 is a forth side view of the Christmas Tree Container, according to the present invention;

FIG. 6 is a top view of the Christmas Tree Container, according to the present invention;

FIG. 7 is a bottom view of the Christmas Tree Container, according to the present invention.

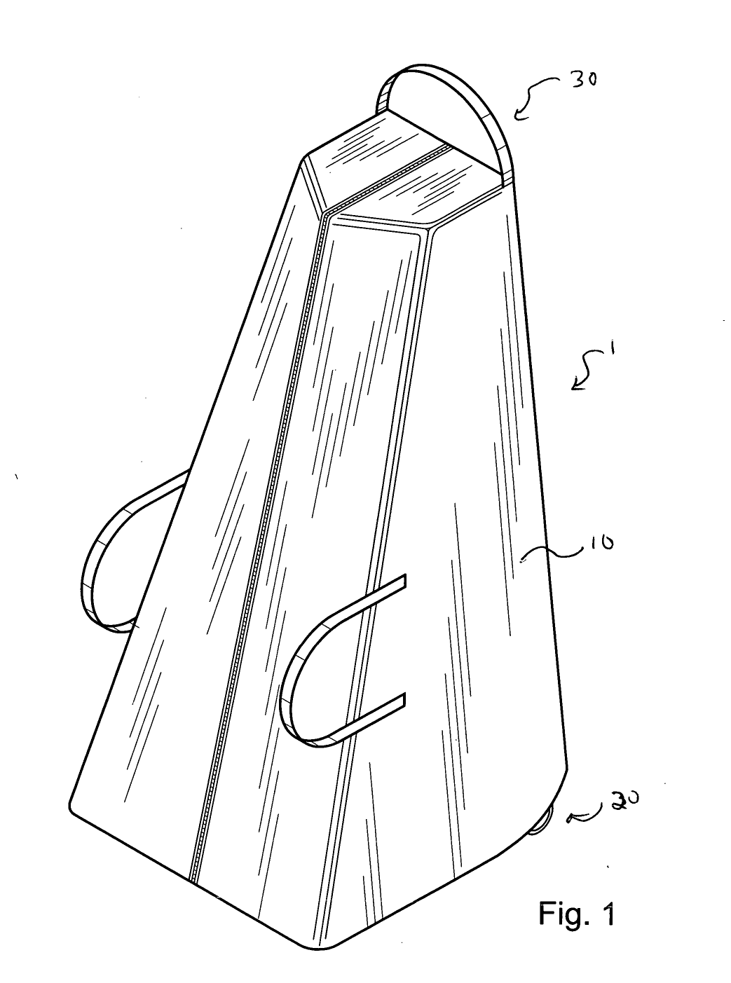

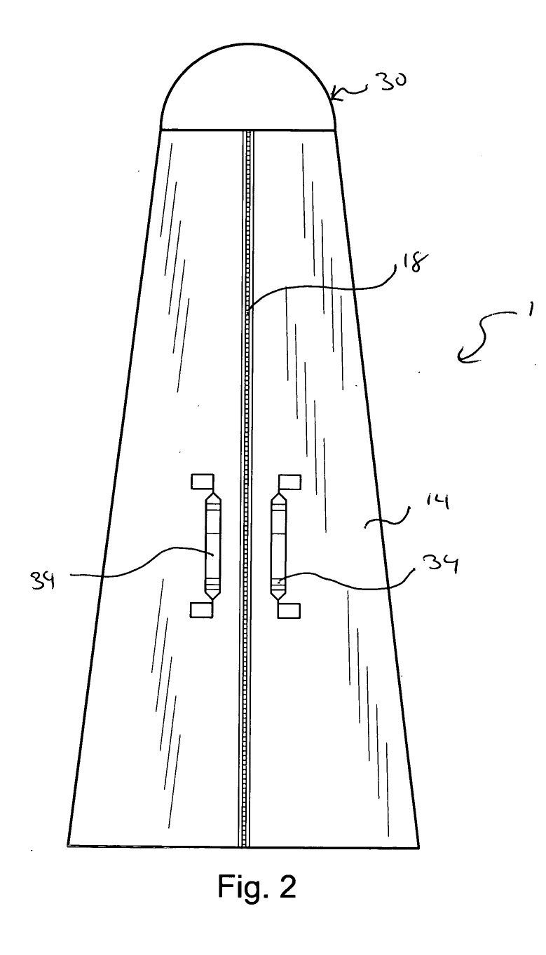

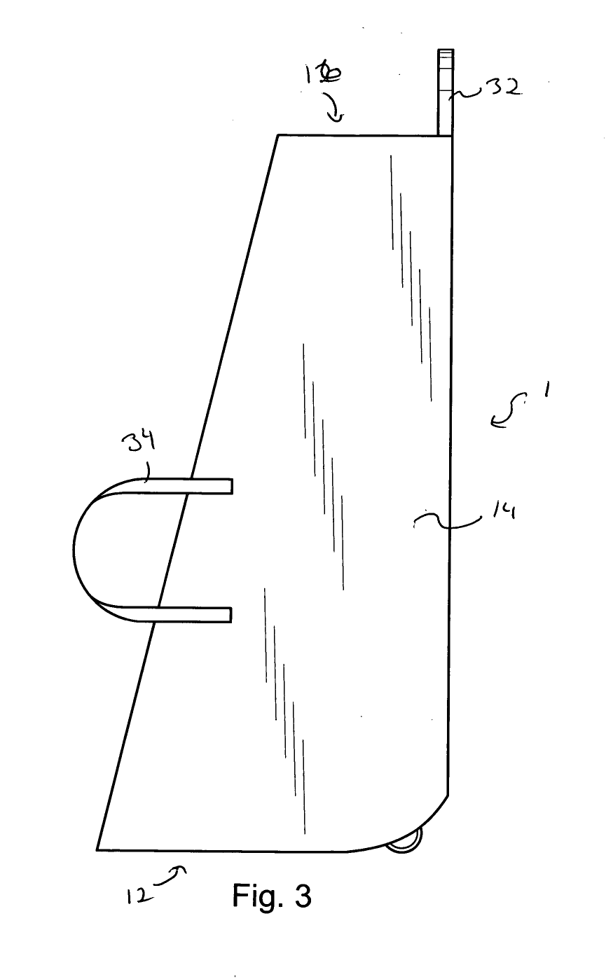

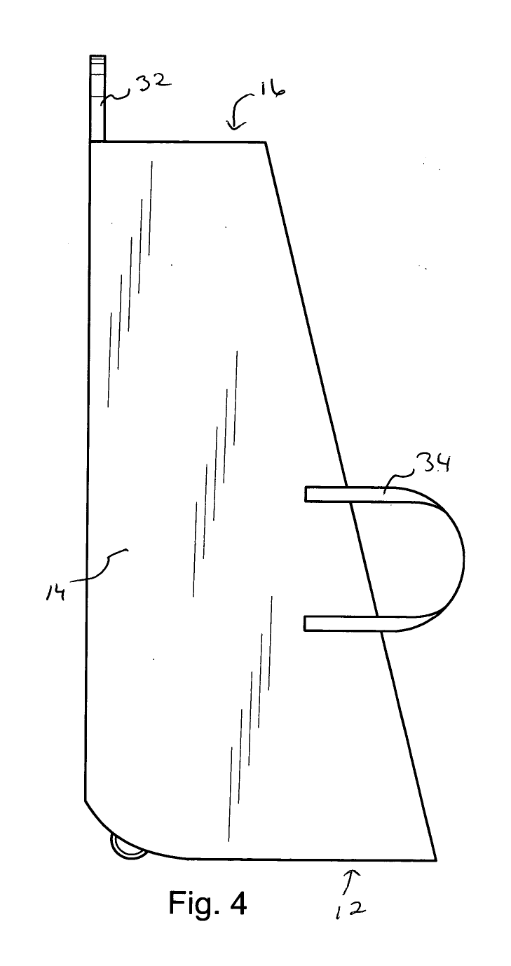

### DESCRIPTION OF PREFERRED EMBODIMENTS

The present invention is useful for storing artificial trees such as artificial Christmas trees.

With reference to the figures, the present invention is a storage container 1 for artificial trees comprising a container portion 10, a transportation portion 20 that is attached to a base 12 of the container portion 10, and a handle portion 30 that is attached to a top end 16 of the container portion 10.

The container portion 10 is preferably made of a soft flexible material such as fabric or the like, such that the container portion may be compressed or rolled-up when not containing an artificial tree. In one embodiment, the container portion 10 is a soft bag without an internal rigid frame. In an alternate embodiment the container portion 10 is a soft bag with an internal rigid frame. In yet another alternate embodiment, the container portion 10 is made of up rigid or quasi-rigid panels flexibly attached to each other such that the container portion 10 may be collapsed when not containing an artificial tree.

In shape the container portion 10 is preferably a truncated pyramid, with a base 12, at least one side section 14 and a top 16. The side section 14 and the top 16, preferably are bisected by a reusable closure mechanism 18, such as a zipper, hook and loop fasteners, buttons, snaps, clasps or the like. In a most preferred embodiment, the at least one side section 14 is four side sections with only one of the side sections 14a being bisected by the closure mechanism 18. In another embodiment of the Container portion, there is only a base 12 and at least one side section 14 that forms a non-truncated pyramid structure. In yet other embodiments of the present invention the container portion 10 may be other shapes, such as rectangular prisms, cubes, ovoids or the like and still fall within the scope of the present invention.

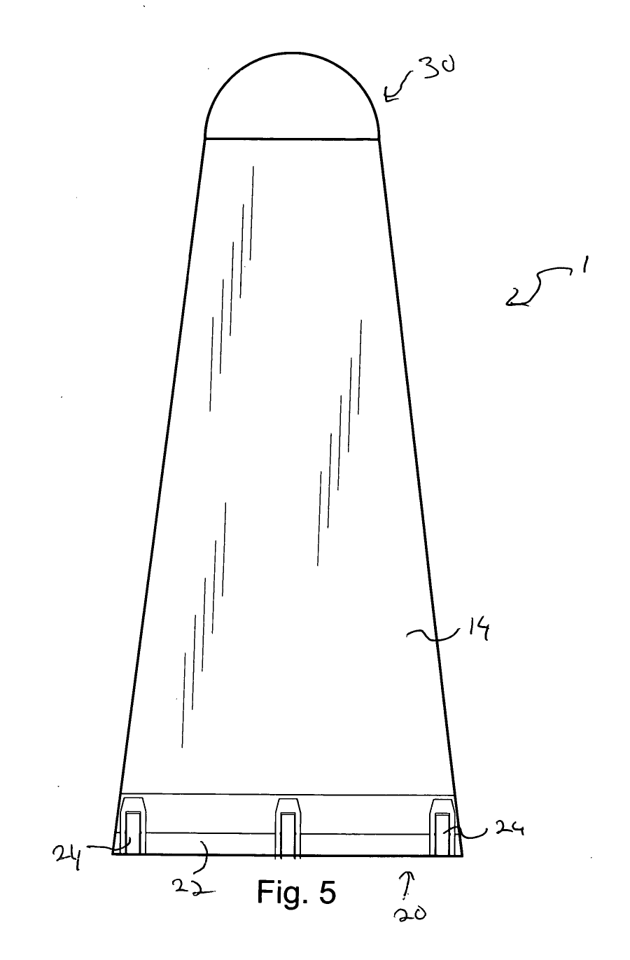

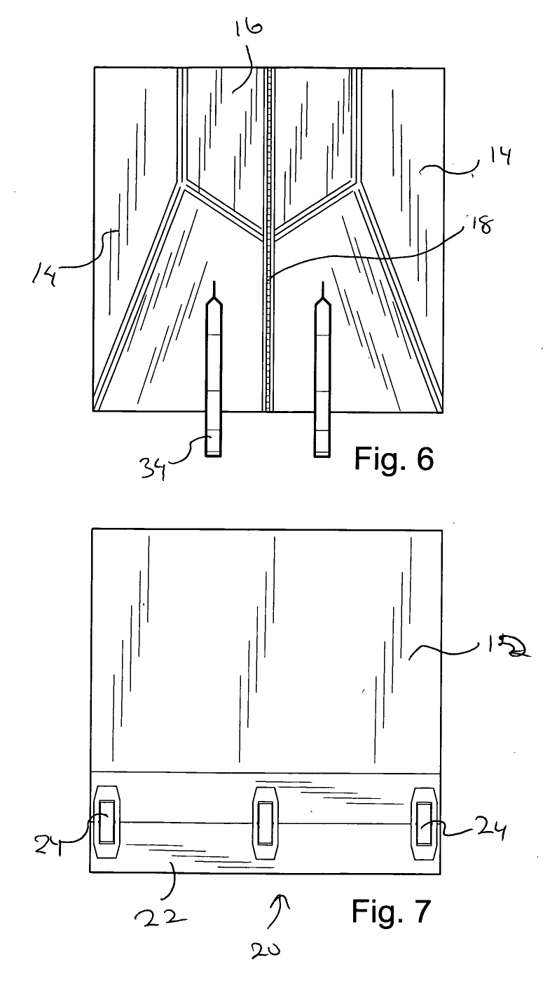

Attached to the base 12 is the transportation portion 20. The transportation portion 20, which is more clearly illustrated in FIG. 5, comprises a rigid or quasi-rigid transverse spine 22 to which at least one, preferably three, wheel mechanisms 24 are attached. The transportation portion 20 is useful in the present invention so that when an artificial tree is placed within the container portion 10 a single individual may move the artificial tree by merely tilting the container portion 10 containing the artificial tree backward such that the weight of the artificial tree is substantially over the transverse spine 22 allowing the whole tree container 1 to ride upon the at least one wheel mechanism 24.

In order to facilitate the movement, or storage of the present invention, attached to an upper end of the container portion 10 is a handle portion 30, which allow a user to conveniently grasp the handle portion 30 while moving the tree container 1, without resort to grasping the larger and bulkier container portion 10. Preferably the handle portion 30 is at least one, preferably one, loop 32 that spans the top of the container portion 10. Additionally, in order to aid lifting the container portion 10 onto a ledge or shelf, the preferred embodiment further includes at least one, preferably two, mid-positioned handles 24 attached to a mid-section of the container body 10.

In the most preferred embodiment, there are multiple tree containers 1 for multi-sectioned artificial trees, one tree container 1 for each section of the artificial tree.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A storage container for artificial trees comprising a container portion, a transportation portion that is attached to a base of the container portion, and a handle portion that is attached to a top end of the container portion.

2. The storage container according to claim 1 wherein the transportation portion comprises a transverse spine and at least one wheel mechanism.

3. The storage container according to claim 2 wherein the transverse spine is a rigid or quasi-rigid material and the at least one wheel mechanism is three wheel mechanisms.

4. The storage container according to claim 1 wherein the container portion is a flexible container portion.

5. The storage container according to claim 1 wherein the container portion is comprised of rigid or quasi-rigid segments flexibly attached to each other such that the container portion is collapsible when not containing an artificial tree.

6. The storage container according to claim 3 wherein the container portion is a flexible container portion.

7. The storage container according to claim 3 wherein the container portion is comprised of rigid or quasi-rigid segments flexibly attached to each other such that the container portion is collapsible when not containing an artificial tree.

8. The storage container according to claim 1 wherein the handle portion is a single loop that spans the top of the container portion.

9. The storage container according to claim 6 wherein the handle portion is a single loop that spans the top of the container portion.

10. The storage container according to claim 7 wherein the handle portion is a single loop that spans the top of the container portion.

11. The storage container according to claim 1 further comprising at least one mid-positioned handle attached to a mid-section of the container body.

12. The storage container according to claim 8 further comprising at least one mid-positioned handle attached to a mid-section of the container body.

13. The storage container according to claim 9 further comprising at least one mid-positioned handle attached to a mid-section of the container body.

14. The storage container according to claim 10 further comprising at least one mid-positioned handle attached to a mid-section of the container body.
